(19) United States
(12) Patent Application Publication
(10) Pub. No.: US 2006/0083248 A1
(43) Pub. Date: Apr. 20, 2006

(54) Apparatus and method for internet protocol allocation

(75) Inventors: Chih Hua Huang, Cingshuei Township (TW); Chun Feng Liu, Taipei City (TW); Jin Ru Chen, Taichung City (TW)

Correspondence Address: TROXELL LAW OFFICE PLLC, SUITE 1404, 5205 LEESBURG PIKE, FALLS CHURCH, VA, 22041, US

(73) Assignee: REALTEK SEMICONDUCTOR CORP.

(21) Appl. No.: 11/236,674

(22) Filed: Sep. 28, 2005

(30) Foreign Application Priority Data
Oct. 1, 2004 (TW) 093129765

(51) Int. Cl. H04L 12/56

(52) U.S. Cl. 370/395.52

(57) ABSTRACT

An Internet protocol (IP) allocation apparatus and method, used in a gateway coupled between an external network and an internal network, is disclosed. The apparatus can receive a request for IP allocation from a node of the internal network, and allocate an available global or private IP to the node according to an allocation principle. If the allocated IP is a global IP, then the node can use it to establish a connection with the external network directly.

### BACKGROUND OF THE INVENTION

(a). Field of the Invention

The present invention relates to the field of network system, and more particularly, to the technical field of IP allocation and packet forwarding.

(b). Description of the Prior Arts

The internal network, such as the Ethernet local area network, usually connects to the external network, such as the Internet, via a gateway or a router, as shown in FIG. 1. However, a conventional gateway uses Dynamic Host Configuration Protocol (DHCP) to allocate the IP address (usually abbreviated as IP) for nodes of the internal network, i.e., when one of the nodes of the internal network needs an IP, the gateway will only dynamically allocate a private IP for the node. When the node is going to make a connection with external network, it has to get a global IP from the gateway (such as the global IP received from the Internet service provider (ISP) through a dialing-up process). Since all the internal network nodes depends on this only global IP to connect to the external network, it is essential that all the connections between the internal and the external networks execute Network Address Translation (NAT) or Network Address-Port Translation (NAPT), to allow for interchanges between the private IP (used only in the internal network) and the global IP.

Yet, nowadays most ISPs provide more than one global IP (such as several floating IPs) to their clients. Therefore, under the NAT/NAPT configuration applied in the conventional gateway (i.e., all the internal network nodes are allocated a private IP, and connect to the external network through only one global IP), there will be some unused and wasted global IPs. However, if one selects a conventional Layer 2 switch to fully utilize the global IPs provided by the ISP instead of using a gateway or router, which has better network security, the information of the internal network will be un-protected.

### SUMMARY OF THE INVENTION

It is therefore one of objectives of this invention to provide an apparatus and method for IP allocation used in a gateway or router. The apparatus and method can dynamically allocate a global or private IP to the internal network node, and, with the help of specific tables, enable the node having a global IP to directly connect with the external network and functions as a firewall to block unknown outside interference. Thus, the provided global IPs can be fully used, with network security being retained at the same time.

According to one embodiment of this invention, an apparatus for IP allocation is provided. The apparatus is used in a gateway coupled between an external network and an internal network. The apparatus includes an allocation module comprising a plurality of global IPs and private IPs. The allocation module is for receiving an IP allocation request of a node of the internal network and allocating a first IP of the plurality of global and private IPs to the node according to the IP allocation request. The apparatus also includes a look-up table which is coupled to the allocation module and contains at least one storage unit for storing a correspondence of the first IP and a network session. Further, a connection of the node and the external network is established according to the first IP if the first IP is one of the global IPs.

According to another embodiment of this invention, a method for IP allocation is provided. The method is used in a gateway coupled between an external network and an internal network and comprises a plurality of global IPs and private IPs. The method includes the steps of: receiving an IP allocation request of a node of the internal network; and allocating a first IP of the plurality of global and private IPs to the node according to the IP allocation request; wherein a connection of the node and the external network is established according to the first IP if the first IP is one of the global IPs.

### BRIEF DESCRIPTION OF THE DRAWINGS

FIG. 1 is a diagram of the connection of an internal network to an external network via a gateway or a router.

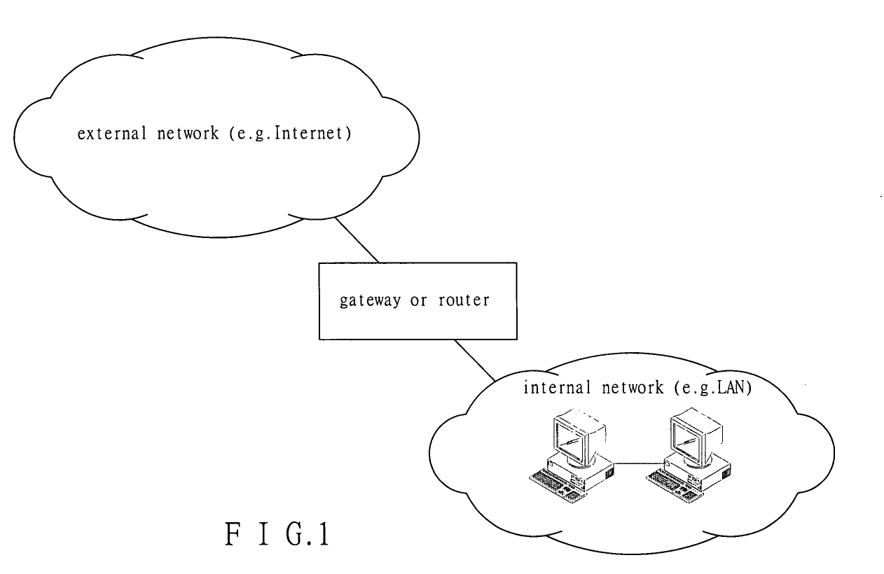

FIG. 2 is a block diagram of a preferred embodiment of the IP allocation device of the present invention.

FIG. 3 is a block diagram of an embodiment of the data structure of the look-up table in FIG. 2.

FIG. 4 is a diagram of one example of the data structure of the look-up table in FIG. 3.

FIG. 5 is a block diagram of an embodiment of the data structure of the SPI table in FIG. 2.

FIG. 6 is a flowchart of the forwarding of an internal-to-external packet in cooperation with the preferred embodiment of the IP allocation method.

FIG. 7 is a flowchart of the forwarding of an external-to-internal packet in cooperation with the preferred embodiment of the IP allocation method.

### DETAILED DESCRIPTION OF THE INVENTION

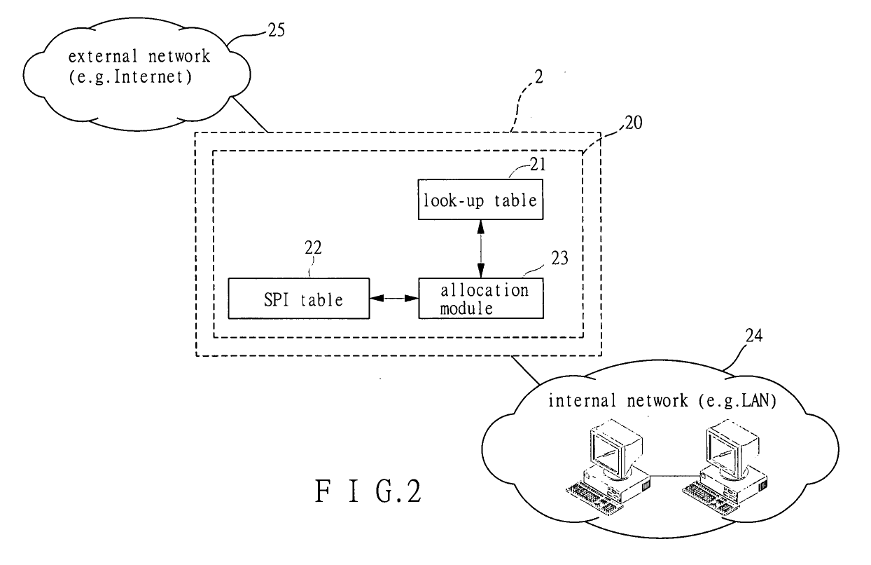

FIG. 2 is a blocked diagram of a preferred embodiment of the IP allocation device of the present invention. As shown in FIG. 2, the IP allocation device 20 is employed in a gateway 2. The gateway 2 is connected between an internal network 24 and an external network 25 and serves as a connection media in between the two networks. The IP allocation device 20 includes: a look-up table 21 to record a correspondence of an established network session and an allocated IP of a node of the internal network 24; a stateful packet inspection (SPI) table 22 to record a connection established by the node allocated with a global IP to the external network 25; and an allocation module 23 to allocate an IP to the node of the internal network 24, and to update the contents of the look-up table 21 and the SPI table 22.

The allocation module 23 comprises a plurality of available global IPs and private IPs. When the node of the internal network 24 issues an IP allocation request, the allocation module 23 allocates one available global or private IP to the node in accordance with an allocation principle. The allocation principle can be designed according to practical needs. For Example, to fully utilize the available global IPs, it can be designed to allocate an available global IP to the node prior to allocating a private IP unless the global IP is used up. When the allocation module 23 allocates an available IP to the node, it will at the same time establish a corresponding session between the internal network 24 and the external network 25 to forward the packet that communicates between the node and the external network 25. The correspondence between the allocated IP and the established network session is recorded in the look-up table 21 by the allocation module 23. It should be noted that the allocation module 23 needs to retain one of the available global IPs for all nodes of the internal network 24 allocated with a private IP to connect to the external network 25 (at this time, the gateway 2 needs to execute NAT/NAPT). Except for this retained global IP, other global IPs can be directly allocated to the node. In an embodiment, the session established by the allocation module 23 when allocating the IP is a point-to-point session. Examples of the point-to-point session include PPP (point-to-point protocol) session, PPPoE (PPP over Ethernet) session, PPTP (point-to-point tunneling protocol) session, L2TP (link-layer tunneling protocol) session, etc. In another embodiment, the session established by the allocation module 23 when allocating the IP is an Ethernet session.

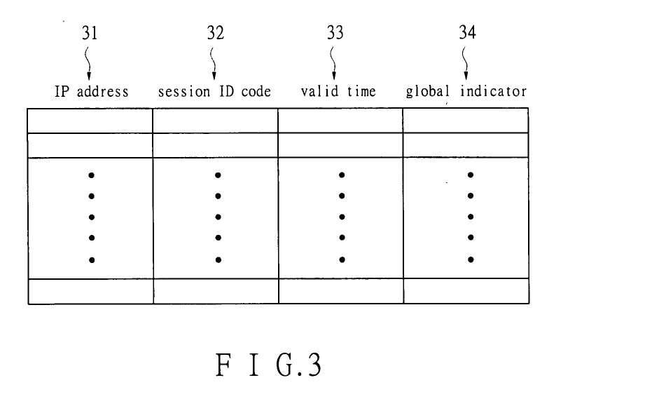

FIG. 3 shows a block diagram of an embodiment of data structure of the look-up table 21 in FIG. 2. As shown in FIG. 3, the look-up table 21 is a cache memory with a plurality of entries. Each entry includes fields for IP address 31, session ID code 32, valid time 33 and global indicator 34, which are further described as follows:

IP address 31: records the IP allocated to the node of the internal network 24 in accordance with the edition of IP used in the Internet nowadays. This field consists of 32 bits.

Session ID code 32: records the ID code of the corresponding session for the IP allocated to the node.

Valid time 33: displays the length of the valid time for the storage content of the current entry. This field can be set up in accordance with actual needs. When the valid time has passed, the current entry can be used for recording a new corresponding relationship between IP and session, thereby effectively utilizing the limited space of the look-up table 21.

Global indicator 34: displays whether the allocated IP is a global IP. In an embodiment, the global indicator 34 is one-bit long. The bit value of 1 means that a global IP is allocated, and 0 means a private IP is allocated.

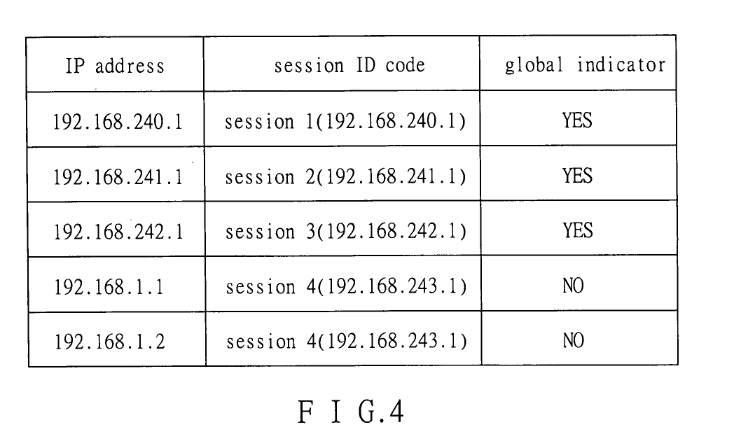

FIG. 4 is a diagram showing an example of the data structure of the look-up table 21 in FIG. 3 (the valid time 33 field is not shown). As shown in FIG. 4, five IPs are allocated. Three of them are global IPs (i.e., 192.168.240.1, 192.168.241.1, and 192.168.242.1), while the other two are private IPs (i.e., 192.168.1.1, and 192.168.1.2). In this embodiment, four global IPs are provided, and one of them (i.e., 192.168.243.1) is reserved for the node allocated with a private IP, so that after the process of NAT/NAPT, the node with the private IP can make use of the same session (session 4 for this example) to connect with the external network 25. Furthermore, each session ID code in this example is actually a global IP (i.e., either the global IP allocated to the node or the reserved global IP), such as what is shown in the bracket in the session ID code column of FIG. 4.

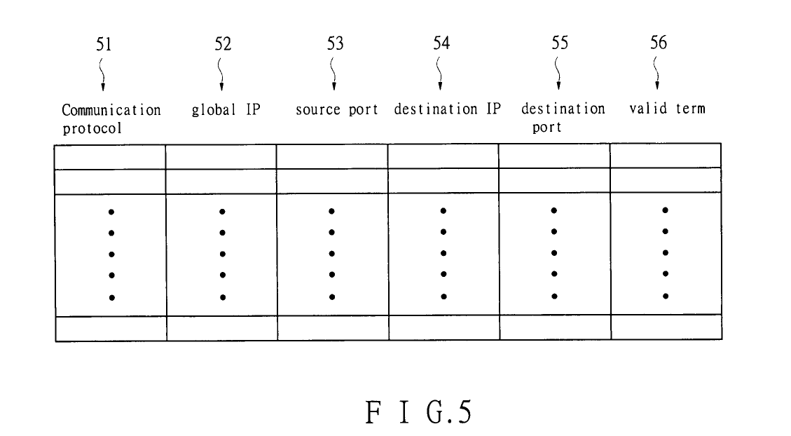

FIG. 5 is a block diagram of an embodiment of the data structure of the SPI table 22 in FIG. 2. The SPI table 22 is used for recording the connections made between the nodes allocated with global IPs and the external network 25. Therefore, the SPI table 22 can be a cache memory with a plurality of entries; each entry includes fields for communication protocol 51, global IP 52, source port 53, destination IP 54, destination port 55 and valid term 56, as shown in FIG. 5. These fields can record the two end nodes, the communication protocol and the valid term of the connection. The valid term 56 is used to determine if the recorded connection has exceeded a time limit. The SPI table 22 is designed for the nodes of the internal network that have global IPs allocated, thereby preventing from unnecessary interference for these nodes. This will be further described later.

According to the look-up table 21 and the SPI table 22, the gateway 2 forwards the internal-to-external packet from the internal network 24 to the external network 25 and the external-to-internal packet from the external network 25 to the internal network 24. When the gateway 2 receives an internal-to-external packet, it will first look up the look-up table 21. If the source IP of the internal-to-external packet is a global IP stored in the look-up table 21, the gateway 2 will forward the internal-to-external packet to the external network 25 via the network session corresponding to the source IP. The gateway 2 will also look up the SPI table 22 to determine if the network connection to which the internal-to-external packet belongs is recorded in the SPI table 22. If not recorded in the SPI table 22, the network connection will be recorded in the SPI table 22 for future determination if an internal-to-external packet received later belongs to the same connection. If the source IP is a private IP stored in the look-up table 21, the gateway 2 will first execute NAT/NAPT for the internal-to-external packet and then forward the internal-to-external packet to the network session corresponding to the source IP. Using FIG. 4 as an example, if the source IP of the internal-to-external packet is 192.168.241.1, it will be forwarded to the network session 2, and if the source IP is 192.168.1.1, it will be forwarded to the network session 4.

On the other hand, when the gateway 2 receives an external-to-internal packet transferred from the external network 25 to the internal network 24, it will also look up the look-up table 21. If the destination IP of the external-to-internal packet is a global IP stored in the look-up table 21, the gateway 2 will further look up the SPI table 22 to determine if the network connection the external-to-internal packet belongs to is recorded therein. If recorded in the SPI table 22, it means that the external-to-internal packet is a reverse packet of a previously established connection. In that case, the gateway 2 will directly forward the external-to-internal packet according to the destination IP. If not recorded in the SPI table 22, it means the external-to-internal packet is an unidentified interference which should be discarded. If the destination IP of the external-to-internal packet is not stored in the look-up table 21, it means the packet may be sent to a node of the internal network 24 that uses a private IP. In that case, the gateway 2 needs to execute NAT/NAPT to translate the destination IP and forwards the external-to-internal packet according to the translated destination IP.

In an embodiment, the gateway 2 includes a routing table to help determine the route of packet forwarding. However, if the allocation module 23 allocates a global IP to a node of the internal network 24, the allocation module 23 will renew the routing table so that the gateway 2 can forward an internal-to-internal packet from the internal network 24 to the node in accordance with the routing table. For example, if each entry of the routing table stores a destination IP and a corresponding gateway IP, the allocation module 23 will set up both the destination IP and the gateway IP of an entry as the global IP allocated to the node. In this embodiment, the gateway 2 directly forwards an internal-to-internal packet that communicates between the nodes of the internal network 24 and an external-to-external packet that communicates between the nodes of the external network 25 through the routing table.

According to a preferred embodiment of the IP allocation method of this invention, the look-up table 21 and the SPI table 22 are respectively updated for subsequent packet forwarding when an IP is allocated to a node of the internal network 24 and when the connection between the node of the internal network 24 and the external network 25 is established. The manner to update these tables is described as above. In this preferred embodiment, when a node of the internal network 24 requests an IP allocation, an allocation principle will be followed to allocate an available IP to the node. While the IP is allocated, a corresponding session that connects the internal network 24 and the external network 25 will be established, and the correspondence of the allocated IP and the established session will be recorded in one of the entries of the look-up table 21. Also, at the same time, the valid time 33 and the global indicator 34 fields will be set.

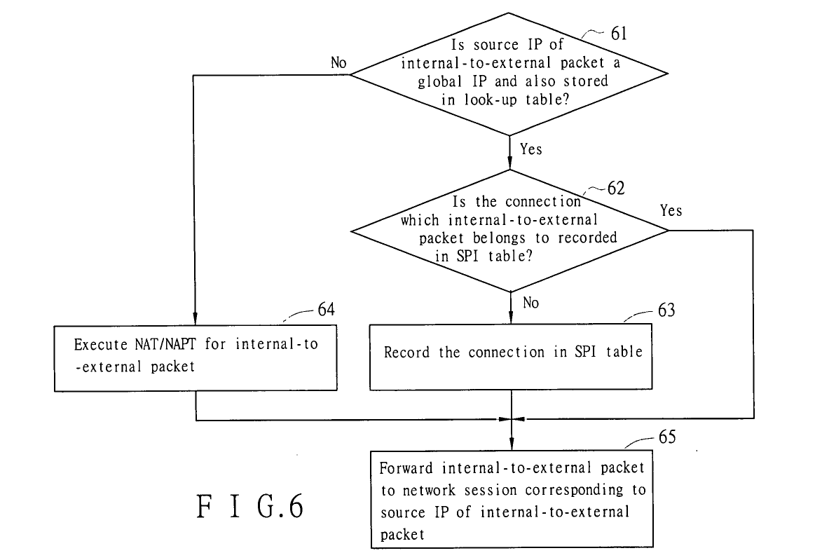

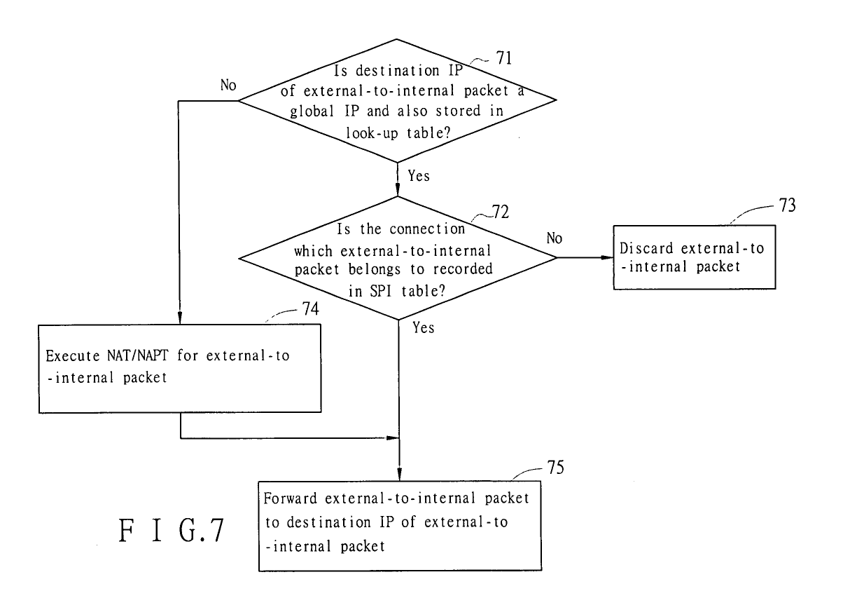

To co-operate with the preferred embodiment of the IP allocation method mentioned above, the forwarding of the external-to-internal packet and the internal-to-external packet is dealt with differently, and will be discussed with regard to FIG. 6 and FIG. 7 respectively. FIG. 6 shows a flowchart of forwarding an internal-to-external packet. As shown in FIG. 6, this flow includes the following steps:
Step 61: Determine if the source IP of the internal-to-external packet is stored in the look-up table 21 and is also a global IP. If yes, go to step 62; if not, go to step 64;
Step 62: Determine if the connection which the internal-to-external packet belongs to is recorded in the SPI table 22. If no, go to step 63; if yes, go to step 65;
Step 63: Record the connection in the SPI table 22, and then go to step 65;
Step 64: Execute NAT/NAPT for the internal-to-external packet; and
Step 65: Forward the internal-to-external packet to the network session corresponding to the source IP of the internal-to-external packet.

Step 61 determines whether the internal-to-external packet is issued from the node of the internal network 24 with a previously allocated IP, and whether the allocated IP is a global IP. If the allocated IP is a global IP, the packet will be directly forwarded to the corresponding network session (step 65); if the allocated IP is a private IP, the packet has to go through a NAT/NAPT execution (step 64) before forwarded to the corresponding session (step 65). Besides, when the node allocated with a global IP makes a connection with the external network 25, the connection needs to be recorded in the SPI table 22 (steps 62 and 63), thereby determining whether subsequent external-to-internal packets are an undefined interference (please refer to the part about FIG. 7).

FIG. 7 is a flowchart of forwarding an external-to-internal packet in cooperation with the preferred embodiment of the IP allocation method. As shown in FIG. 7, the flow includes the following steps:
Step 71: Determine whether the destination IP of the external-to-internal packet is stored in the look-up table 21 and is also a global IP. If yes, go to step 72; if not, go to step 74;
Step 72: Determine if the connection which the external-to-internal packet belongs to is recorded in the SPI table 22. If no, go to step 73; if yes, go to step 75;
Step 73: Discard the external-to-internal packet, and stop the process.
Step 74: Execute NAT/NAPT for the external-to-internal packet; and
Step 75: Forward the external-to-internal packet to the destination IP of the external-to-internal packet.

Step 71 determines if the external-to-internal packet is to be forwarded to a node of the internal network 24 with a previously allocated global IP. If yes, it will be further determined if the external-to-internal packet is a reverse packet of a previously established connection (step 72). If the external-to-internal packet is the reverse packet, the packet will be directly forwarded to its destination IP (step 75). If the external-to-internal packet doesn't belong to the previously established connection, the external-to-internal packet will be discarded. If the result of step 71 is no, it means the external-to-internal packet is to be forwarded to the node allocated with a private IP. Therefore, the packet has to go through a NAT/NAPT execution (step 74) and then is forwarded to the translated destination IP (step 75).

In another embodiment, the IP allocation method of this invention also includes: if a node of the internal network 24 is allocated with a global IP, a routing table will be renewed so that it could be used accordingly for forwarding an internal-to-internal packet from the internal network 24 to that node. In this embodiment, the internal-to-internal packet between internal network 24 nodes and the external-to-external packet between external network 25 nodes are forwarded by means of the routing table.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. An internet protocol (IP) allocation method used in a network device which is coupled between an external network and an internal network, the network device comprising a plurality of global IP addresses and private IP addresses, the method comprising the steps of:
receiving an IP allocation request of a node of the internal network; and
allocating a first IP address of the plurality of global IP addresses and private IP addresses to the node of the internal network according to the IP allocation request;
wherein a connection of the node and the external network is established according to the first IP address if the first IP address is one of the global IP addresses.

2. The method of claim 1, further comprising:
updating a routing table of the network device if the first IP address is the global IP address;
wherein the routing table comprises a plurality of entries, each entry comprises a destination IP field and a corresponding gateway IP field, wherein the step of updating the routing table is executed such that both the corresponding gateway IP field and the destination IP field of one of the entries store the first IP address.

3. The method of claim 1, further comprising:
storing the first IP address and a corresponding network session into a look-up table, wherein the look-up table is used for forwarding an internal-to-external packet from the internal network to the external network, and forwarding an external-to-internal packet from the external network to the internal network.

4. The method of claim 3, wherein the internal-to-external packet is forwarded to the network session corresponding to a source IP address of the internal-to-external packet when the source IP address of the internal-to-external packet is a global IP address and is stored in the look-up table.

5. The method of claim 3, wherein the internal-to-external packet is performed a network address translation (NAT) or network address-port translation (NAPT) and is forwarded to the network session corresponding to a source IP address of the internal-to-external packet when the source IP address of the internal-to-external packet is a private IP and is stored in the look-up table.

6. The method of claim 3, wherein the external-to-internal packet is forwarded to a destination IP address of the external-to-internal packet when the destination IP of the external-to-internal packet is a global IP address and is stored in the look-up table.

7. The method of claim 3, wherein the connection of the node and the external network is recorded in a stateful packet inspection (SPI) table if the first IP address of the node is the global IP address.

8. An internet protocol (IP) allocation apparatus used in a network device which is coupled between an external network and an internal network, the apparatus comprising:
an allocation module comprising a plurality of global IP addresses and private IP addresses, the allocation module being used for receiving an IP allocation request of a node of the internal network, and allocating a first IP address of the plurality of global IP addresses and private IP addresses to the node of the internal network according to the IP allocation request; and
a look-up table, coupled to the allocation module, comprising at least one storage unit for storing a correspondence of the first IP address and a network session;
wherein a connection of the node and the external network is established according to the first IP address if the first IP address is one of the global IP addresses.

9. The apparatus of claim 8, wherein the allocation module reserves one of the global IP addresses for performing a network address translation (NAT) or network address-port translation (NAPT).

10. The apparatus of claim 8, wherein the network session is a point-to-point session or an Ethernet session.

11. The apparatus of claim 8, wherein the storage unit of the look-up table comprises a valid time field for indicating a valid period of the correspondence of the first IP address and the network session.

12. The apparatus of claim 8, wherein the storage unit of the look-up table comprises a global field for indicating whether the first IP address is the global IP address or not.

13. The apparatus of claim 8, wherein when a source IP address of an internal-to-external packet forwarded from the internal network to the external network is a global IP address and is stored in the look-up table, the network device forwards the internal-to-external packet into the network session corresponding to the source IP address of the internal-to-external packet.

14. The apparatus of claim 8, wherein when a source IP address of the internal-to-external packet is a private IP address and is stored in the look-up table, the network device performs a network address translation (NAT) or network address-port translation (NAPT) of the internal-to-external packet, and forwards the translated internal-to-external packet into the network session corresponding to the source IP address of the internal-to-external packet.

15. The apparatus of claim 8, wherein when a destination IP address of an external-to-internal packet forwarded from the external network to the internal network is a global IP address and is stored in the look-up table, the network device forwards the external-to-internal packet to the destination IP address of the external-to-internal packet.

16. The apparatus of claim 8, further comprising:
a stateful packet inspection (SPI) table, coupled to the allocation module, for recording the connection of the node and the external network when the first IP address of the node is the global IP address.

17. The apparatus of claim 16, wherein the network device forwards an external-to-internal packet when a destination IP address of the external-to-internal packet is a global IP address and is stored in the look-up table and when a connection associated with the external-to-internal packet is recorded in the SPI table.

18. The apparatus of claim 8, wherein the network device further comprises a routing table comprising a plurality of entries, each of which is used for storing at least one destination IP address and a corresponding gateway IP address, wherein when the first IP address is the global IP address, the network device updates the routing table so that both the destination IP address and the corresponding gateway IP address in one of the entries are the first IP address.

19. A network device coupled between an external network and an internal network, the network device comprising a plurality of global IP addresses, wherein the network device reserves one of the global IP addresses to perform a network address translation (NAT) or network address-port translation (NAPT), and allocates at least one of the remaining global IP addresses to at least one node of the internal network according to an IP allocation request of the at least one node of the internal network.

20. The network device of claim 19, wherein the network device is a gateway.
